(19) United States
(12) Patent Application Publication
(10) Pub. No.: US 2008/0143871 A1
(43) Pub. Date: Jun. 19, 2008

(54) Camera module having a ground dummy board

(75) Inventor: Min Chul Go, Suwon (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., SUWON (KR)

(21) Appl. No.: 12/000,103

(22) Filed: Dec. 7, 2007

(30) Foreign Application Priority Data
Dec. 13, 2006 (KR) 10-2006-127130

(51) Int. Cl. H04N 5/225

(52) U.S. Cl. 348/374

(57) ABSTRACT

A camera module having a ground dummy board, the camera module including: a lens holder having at least one lens; an image sensor having an image region where light passed through the lens is imaged; a board having the image sensor mounted at one side assembled to a lower surface of the lens holder; and a ground dummy board disposed on an outer surface of the board to electrically connect to ground via holes exposed to the outer surface of the board. The camera module minimally experiences electromagnetic interference and electrostatic discharge, thereby improved in electrical properties thereof.

### CROSS-REFERENCE TO RELATED APPLICATIONS

This application claims the priority of Korean Patent Application No. 2006-127130 filed on Dec. 13, 2006, in the Korean Intellectual Property Office, the disclosure of which is incorporated herein by reference.

### BACKGROUND OF THE INVENTION

1. Field of the Invention

The present invention relates to a camera module, and more particularly, to a camera module having a ground dummy board which minimally undergoes electromagnetic interference and electrostatic discharge resulting from a board during operation, thereby improved in electrical properties thereof.

2. Description of the Related Art

FIG. 1 is an exploded perspective view illustrating a general camera module. The camera module 1 includes a lens barrel having at least one lens disposed therein, and has a male thread 12 formed on an outer surface of the lens barrel 10 with an exposure hole 14 formed in a top surface thereof.

A housing 20 is threadably assembled to the lens barrel 10, and has an opening with a female thread 22 formed on an inner circumferential surface thereof to be threadably engaged with the male thread 12. The opening has an infrared (IR) cut filter 25 for blocking infrared rays contained in light passed through the lens.

An image sensor 30 is disposed under the housing 20 and has an image region where an image of an object passed through the lens of the lens barrel 10 is formed. The image sensor 30 is flip-chip bonded to one side of the board 40 to be electrically connected thereto. The side of the board 40 where the image sensor 30 is mounted is assembled to a lower surface of the housing 20.

The board 40 has a window 44 formed at the one side to expose the image region of the image sensor 30, and connection terminals 41 electrically connected to bumps 31 formed on a top of the image sensor 30. The board 40 has a connector 45 disposed at another side for electrical connection with an unillustrated display unit.

Here, the image sensor 30 is flip-chip bonded to a bottom of the one side of the board 40, but not limited thereto. The image sensor 30 may be wire-bonded to a top of the one side of the board 40 by a plurality of wires.

The board 40 is a flexible printed circuit board (FPCB). As a way to manufacture the board 40, conductive layers are thermo-compressed on a top and bottom of an insulating layer of the board 40, and dry films are laminated on the conductive layers to form circuit patterns. Subsequently, the dry films laminated are exposed and etched to form predetermined circuit patterns 42 electrically connecting the image sensor 30 with the connector 45. Moreover, coverlays (not shown), i.e., board protective films are formed on a top and bottom of the board 40 to protect the circuit patterns from external environment.

Meanwhile, during operation of the camera module 1, an analogue electrical signal of the image obtained from the image region of the image sensor 30 is converted into a digital electrical signal by a converter (not shown) and then transmitted to the connector 45 through the circuit patterns 42.

In this process, electromagnetic waves are generated from the circuit patterns 42 of the board 40. The electronic magnetic waves are then radiated outside to electromagnetically interfere with neighboring electronic parts, thereby triggering electromagnetic interference (EMI). Furthermore, electromagnetic waves generated from other electronic parts may affect the board 40 to induce electromagnetic interference. In addition, static electricity may be discharged in an electro-static discharge (ESD) phenomenon. These problems disadvantageously degrade electrical properties of the camera module.

### SUMMARY OF THE INVENTION

An aspect of the present invention provides a camera module having a ground dummy board in which electromagnetic interference and electro-static discharge are maximally suppressed to improve electrical properties of the camera module.

According to an aspect of the present invention, there is provided a camera module having a ground dummy board, the camera module including: a lens holder having at least one lens therein; an image sensor having an image region where light passed through the lens is imaged; a board having the image sensor mounted at one side assembled to a lower surface of the lens holder; and a ground dummy board disposed on an outer surface of the board to electrically connect to ground via holes exposed to the outer surface of the board.

The ground dummy board may include: a ground layer having both ends electrically connected to the ground via holes exposed to the board, by a conductive adhesive; and protective layers disposed on a top and bottom of the ground layer, respectively.

The ground dummy board may be bonded to at least one of a top and a bottom of the board by an adhesive.

The ground via holes may be formed of one of a through via hole and a blind via hole electrically connected to a ground line out of circuit patterns formed on the board.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exploded perspective view illustrating a general camera module;

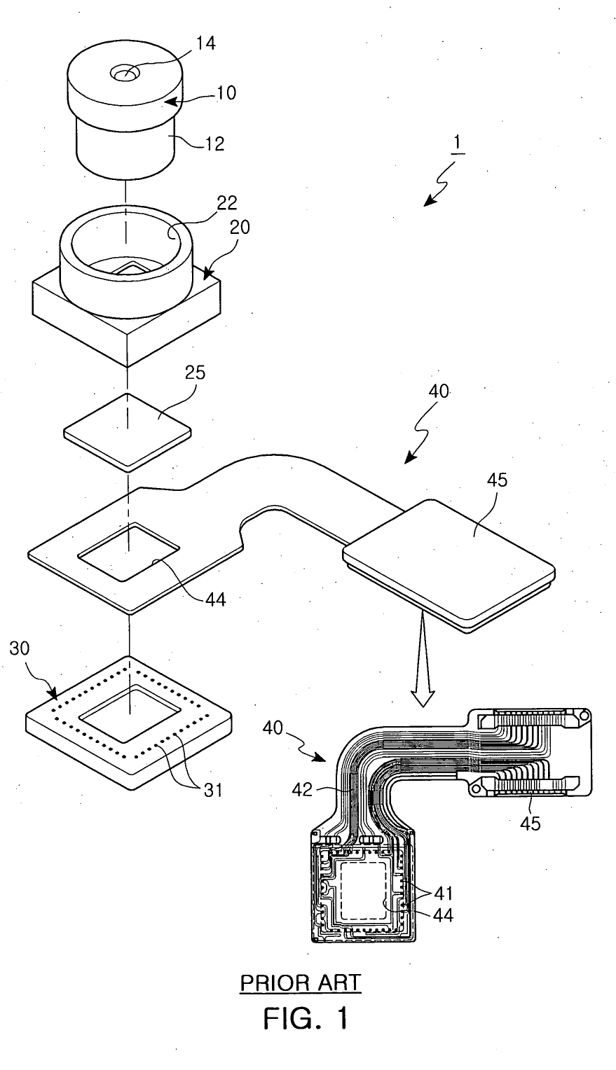

FIG. 2 is an exploded perspective view illustrating a camera module having a ground dummy board according to an exemplary embodiment of the invention; and

FIG. 3 is a cross-sectional view illustrating a dummy board and a board which are connected together in a camera module having a dummy board according to an exemplary embodiment of the invention.

### DETAILED DESCRIPTION OF THE PREFERRED EMBODIMENT

Exemplary embodiments of the present invention will now be described in detail with reference to the accompanying drawings.

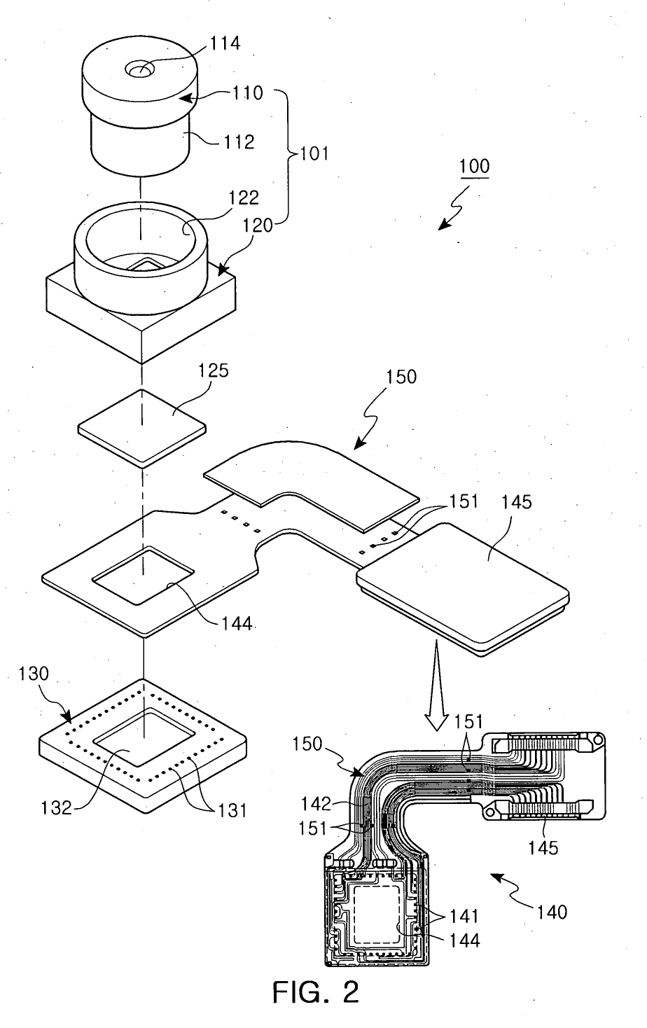

FIG. 2 is an exploded perspective view illustrating a camera module having a ground dummy board according to an exemplary embodiment of the invention. The camera module 100 includes a lens holder 101, an image sensor 130, a board 140 and a ground dummy board 150.

The lens holder 101 includes a lens barrel 110 and a housing 120. The lens barrel 110 is a hollow with at least one lens disposed therein and has a male thread 112 formed on an outer surface thereof. The housing 120 has a female thread 122 formed on an inner circumferential surface thereof corresponding to the male thread 112 and is threadably assembled to the lens barrel 110.

The lens barrel 110 is a hollow having a predetermined dimension of inner space so that at least one lens is arranged therein along an optical axis. An opening 114 of a predetermined size is formed in a top of the lens barrel 110 to have its center aligned with the optical axis.

The plurality of lenses are disposed at a predetermined interval in the lens barrel 110 with spacers (not shown) provided therebetween.

The housing 120 includes a tubular portion having the female thread 122 threadably engaged with the male thread 112 of the lens barrel 110, and a square portion assembled with the board 140.

With this threadable engagement with the housing 120, the lens barrel 110 can be disposed movable back and forth in an optical axis direction, thereby varying a focal length between the lens and the image sensor 130.

Meanwhile, an infrared (IR) cut filter 125 is disposed in the housing, i.e., between the lenses arranged in the lens barrel 110 and the image sensor 130 to block infrared rays contained in light incident on the image region.

The image sensor 130 has the image region 132 where an image is formed, on a top surface onto which a focal point of the lens is directed. The image sensor 130 is electrically connected to the board 140 so that the image formed is converted into an electrical signal and then transmitted to a display through the board 140.

A plurality of bumps 131 are formed on an outer periphery of the image region 132 of the image sensor 130 to facilitate flip-chip bonding between the image sensor 130 and the board 140. The image sensor 130 is disposed on a lower surface of one side of the board 140 via a conductive adhesive (not shown) such as an Anisotropic conductive film (ACF) and an Anisotropic conductive paste (ACP).

Here, the image sensor 130 is flip-chip bonded to the one side of the board 140, but not limited thereto. The image sensor 130 may be wire-bonded onto a top of the board 140 by a plurality of wires.

The board 140 has a window 144 formed at the side where the image sensor 130 is mounted to have a size substantially identical to the image area of the image sensor 130.

A plurality of connection terminals 141 are formed on the side of the board where the window 144 is formed to be electrically connected in correspondence with the bumps 131 formed on the image sensor 130.

A connector 145 is disposed at another side of the board 140 to be connected thereto so that an electrical signal fed from the image sensor 130 is transmitted to the board 140. Circuit patterns 142 are formed on a portion of the board 140 between the side where the image sensor 130 is mounted and the side where the connector 45 is disposed, thereby enabling transmission and reception of various electrical signals.

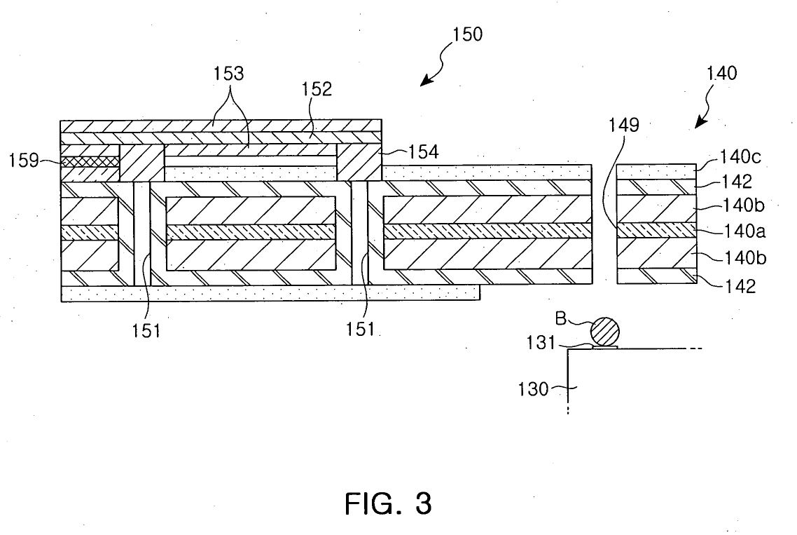

The board 140, as shown in FIG. 3, includes an insulating layer 140a made of a resin-based material such as polyimide and polyester, and conductive layers 140b applied and thermo-compressed on a top and bottom of the insulating layer 140b.

Conductive films are laminated on the conductive layers 140b and then exposed and etched to form predetermined circuit patterns 142 electrically connecting the image sensor 130 with the connector 145. Coverlays 140c, i.e., board protective films are formed on the top and bottom of the board 140 to protect the circuit patterns 142 from external environment.

The ground dummy board 150 is provided on an outer surface of the board 140 to be electrically connected to ground via holes 151 exposed to the outer surface of the board 140.

The ground dummy board 150 includes a ground layer 152 and protective layers 153. The ground layer 152 is electrically connected to the ground via holes 151 exposed through the outer surface of the board 140, by a conductive adhesive 154. The protective layers 153 are formed on a top and bottom of the ground layer 152.

The ground layer 152 is a ground line exposed to the outside at both sides of the ground dummy board 150 to be electrically connected to the ground via holes 151 of the board 140. The protective layers 153 are made of an insulating resin which is applied on the top and bottom of the insulating layer to protect the ground layer 152.

The ground dummy board 150 may be bonded to one of a top and bottom of the board 140 by an adhesive 159, but not limited thereto. The ground dummy boards 150 may be bonded to the top and bottom of the board 140, respectively, by an adhesive.

The ground via holes 151 connected to the ground dummy board 150 are configured as one of a through via hole and a blind via hole electrically connected to a ground line out of the circuit patterns 142 formed on the board 140.

Also, the connection terminals 141 of the board 140 connected to the bumps 131 of the image sensor 130 by a solder ball B may be formed of a terminal connecting via hole 149.

Meanwhile, to ground-connect the ground dummy board 150 to the top of the board 140, first, some portions of the coverlays 140c applied on the outer surface of the board 140 are removed to expose the ground via holes 151 to the outside and a conductive adhesive 154 is applied on one of an upper end and a lower end of the exposed ground via holes 151.

Moreover, portions of the protective layers 153 of the ground dummy board 150 corresponding to the ground via holes 151 of the board are removed to expose both sides of the ground layer 152 to the outside.

Then, the ground dummy board 150 is attached onto the outer surface of the board 140 and the ground via holes 151 are bonded to the ground layer 152 of the ground dummy board 150 by the conductive adhesive 154. With heat and pressure applied to portions corresponding to the conductive adhesive 154, the ground via holes and the ground layer are electrically connected to each other.

As a result, when an electrical signal of the image obtained from the image region of the image sensor 130 is converted into a digital electrical signal and then transmitted to the connector 145 through the circuit patterns 142 of the board 140, electromagnetic waves are generated, without being radiated outward, but absorbed in the ground layer 152 electrically connected to the ground via holes 151. Subsequently, the electromagnetic waves are radiated through the ground line. This prevents noises from occurring in the electrical signal.

Furthermore, the electromagnetic waves generated outside are blocked from affecting the board through the circuit patterns and electro-static discharge (ESD) in which static electricity is discharged is suppressed.

As set forth above, according to exemplary embodiments of the invention, a ground dummy board is provided on an outer surface of a board electrically connecting an image sensor with a connector to be electrically connected to ground via holes of the board. This prevents electromagnetic waves generated from circuit patterns of the board from being radiated outward, thereby affecting neighboring electronic parts, or electromagnetic waves generated outside from being induced into the board. This as a result enhances electrical properties of the camera module and prevents noises from occurring in an electrical signal, thereby achieving a high-quality image.

While the present invention has been shown and described in connection with the exemplary embodiments, it will be apparent to those skilled in the art that modifications and variations can be made without departing from the spirit and scope of the invention as defined by the appended claims.

What is claimed is:

1. A camera module having a ground dummy board, the camera module comprising:
a lens holder having at least one lens;
an image sensor having an image region where light passed through the lens is imaged;
a board having the image sensor mounted at one side assembled to a lower surface of the lens holder; and
a ground dummy board disposed on an outer surface of the board to electrically connect to ground via holes exposed to the outer surface of the board.

2. The camera module of claim 1, wherein the ground dummy board comprises:
a ground layer having both sides electrically connected to the ground via holes exposed to the board, by a conductive adhesive; and
protective layers disposed on a top and bottom of the ground layer, respectively.

3. The camera module of claim 1, wherein the ground dummy board is bonded to at least one of a top and a bottom of the board by an adhesive.

4. The camera module of claim 1, wherein the ground via holes comprise one of a through via hole and a blind via hole electrically connected to a ground line out of circuit patterns formed on the board.
